(19) United States
(12) Patent Application Publication
(10) Pub. No.: US 2006/0174067 A1
(43) Pub. Date: Aug. 3, 2006

(54) Method of caching data

(76) Inventors: Craig Soules, Pittsburgh, PA (US); Arif Merchant, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/051,433

(22) Filed: Feb. 3, 2005

(51) Int. Cl. G06F 13/28

(52) U.S. Cl. 711/135

(57) ABSTRACT

An embodiment of a method of caching data writes data units into a write cache for eventual flushing to storage. The method sets a copy-to-read-cache flag for each particular data unit that is read from the write cache. Upon flushing each data unit to the storage, the method copies the data unit to a read cache if the flag for the data unit is set. Another embodiment of a method of caching data writes data units into a write cache. The method simulates a transfer policy for copying the data units from the write cache to a read cache to determine a performance indicator for the transfer policy. Upon flushing each data unit, the method copies the data unit to the read cache if the performance indicator exceeds a threshold and the transfer policy includes copying the data unit into the read cache.

### FIELD OF THE INVENTION

The present invention relates to the field of data storage. More particularly, the present invention relates to the field of data storage where write and read caches are used to facilitate data transfer to and from the data storage.

### BACKGROUND OF THE INVENTION

Many storage systems employ separate read and write caches to improve access to the storage systems. Data that is read from the storage system is often found in the read cache. When data is written to a storage device, the data may be temporarily held in the write cache and marked as “dirty” (i.e., to be flushed to storage). Eventually, the data that is temporarily held in the write cache is flushed to storage.

One method of improving a hit ratio for the read cache places a copy of write data in the read cache as well as the write cache. Such a technique often fails to improve the hit ratio because it is only in some instances that a significant amount of write data is read from a storage system within a time period for read caching. In other instances, little write data is read from the storage system within the time frame for the read caching.

Another method of improving a hit ratio for the read cache copies a write-cache line into the read cache upon a read of the write-cache line from the write cache. Such a technique makes inefficient use of the write and read caches because two copies of data are cached for a period of time.

### SUMMARY OF THE INVENTION

The present invention comprises a method of caching data. According to an embodiment, the method writes units of data into a write cache for eventual flushing to storage. The method sets a copy-to-read-cache flag for each particular unit of data that is read from the write cache. Upon flushing each unit of data to the storage, the method copies the unit of data to a read cache if the copy-to-read-cache flag for the unit of data is set.

According to another embodiment, the method writes units of data into a write cache for eventual flushing to storage. The method simulates a transfer policy for copying the units of data from the write cache to a read cache upon flushing the units of data to the storage to determine a performance indicator for the transfer policy. Upon flushing each unit of data, the method copies the unit of data to the read cache if the performance indicator exceeds a threshold and the transfer policy includes copying the unit of data into the read cache.

These and other aspects of the present invention are described in more detail herein.

### BRIEF DESCRIPTION OF THE DRAWINGS

The present invention is described with respect to particular exemplary embodiments thereof and reference is accordingly made to the drawings in which:

FIG. 1 illustrates an embodiment of a method of caching data of the present invention as a flow chart;

FIG. 2 schematically illustrates an embodiment of a storage unit which employs an embodiment of a method of caching data of the present invention;

FIG. 3 schematically illustrates an embodiment of a write cache that is employed in an embodiment of a method of caching data of the present invention;

FIG. 4 illustrates an embodiment of a method of caching data of the present invention as a flow chart; and

FIG. 5 illustrates an embodiment of a method of caching data of the present invention as a flow chart.

### DETAILED DESCRIPTION OF A PREFERRED EMBODIMENT

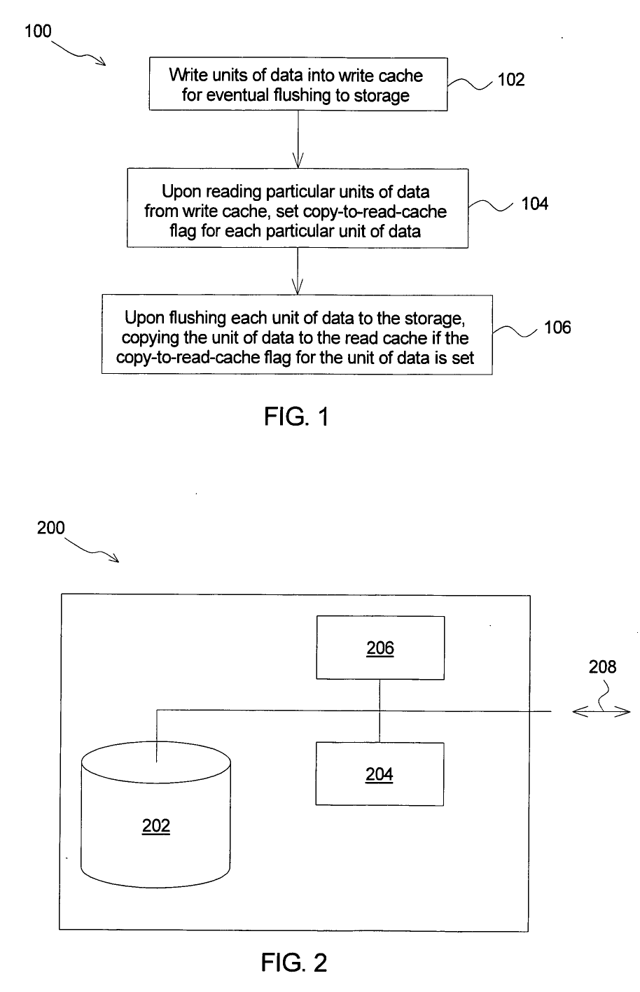

An embodiment of a method of caching data of the present invention is illustrated as a flow chart in FIG. 1. As data is received, the method 100 employs a first step 102 of writing units of data into a write cache for eventual flushing to storage.

An embodiment of a storage unit that employs methods of caching data of the present invention is illustrated schematically in FIG. 2. The storage unit 200 comprises storage 202, a write cache 204, and a read cache 206. Data 208 enters and leaves the storage unit 200 upon write and read commands, respectively. The storage 202 may be a disk, an array of disks, or some other non-volatile storage such as a tape or flash memory. The write cache 204 may be non-volatile random access memory (NVRAM) and the read cache may be RAM. The units of data enter the storage unit 200 and are temporarily cached in the write cache 204 for eventual flushing to the storage 202.

In a second step 104 (FIG. 1), upon reading of particular units of data from the write cache 204 (FIG. 2), the method 100 sets a copy-to-read-cache flag for each particular unit of data.

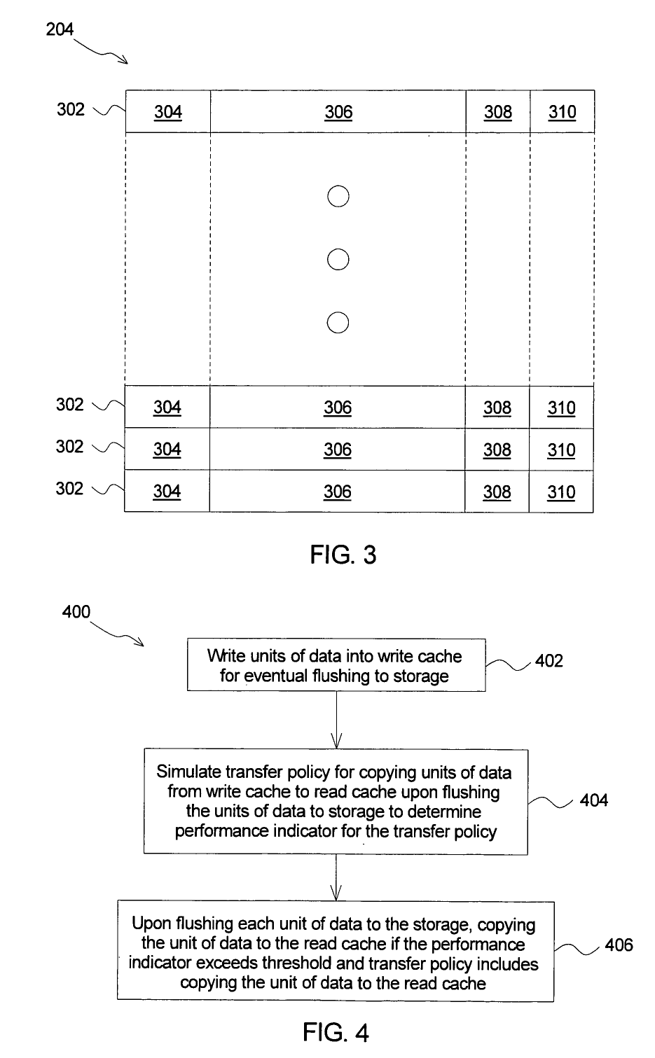

An embodiment of the write cache 204 is schematically illustrated in FIG. 3. The write cache 204 comprises write-cache lines 302. Each write-cache line 302 includes a data identifier 304, write-cache-line data 306, a flush-to-storage identifier 308, and a copy-to-read-cache identifier 310. The data identifier 304 identifies the write-cache-line data 306. The write-cache-line data 306 includes one or more units of data. The units of data may be blocks of data, files, portions of files, or database records. The flush to storage identifier 308 indicates a flush-to-storage flag. For example, a one (i.e., a “dirty” bit) may indicate the flush-to-storage flag and a zero may indicate absence of the flush-to-storage flag. The copy-to-read-cache identifier 310 indicates the copy-to-read-cache flag. For example, a one may indicate the copy-to-read-cache flag and a zero may indicate an absence of the copy-to-read-cache flag.

Upon flushing each unit of data to the storage 202 (FIG. 2), the method 100 (FIG. 1) employs a third step 106 of copying each unit of data to the read cache 206 that has the copy-to-read-cache flag set.

In an alternative embodiment, the method 100 further comprises a fourth step of saving a timestamp for each unit of data that has the copy-to-read-cache flag set that indicates a time when the copy-to-read-cache flag was set or a time of a most recent read of the unit of data. In this alternative embodiment, the method 100 employs the timestamp to determine an insertion point for an identifier for the unit of data in a queue for a caching policy for the read cache 206. The caching policy may be a least recently used caching policy, an adaptive replacement caching policy, a first-in-first-out caching policy, or some other caching policy that employs time to arrange the queue for eviction from the read cache 206.

Another embodiment of a method of caching data of the present invention is illustrated as a flow chart in FIG. 4. The method 400 employs a first step 402 of writing units of data into a write cache 204 (FIG. 2) for eventual flushing to the storage 202. In a second step 404, the method simulates a hypothetical transfer policy for copying the units of data from the write cache 204 to the read cache 206 upon flushing the units of data to the storage 202 to determine a performance indicator for the hypothetical transfer policy. The hypothetical transfer policy may be an always transfer policy or some other transfer policy such as a never transfer policy. The second step 404 may employ a ghost cache (i.e., a meta-data structure which simulates a cache but which does not include the cached data).

Upon flushing each unit of data to the storage 202, the method 400 (FIG. 4) copies each unit of data to the read cache 206 if the performance indicator exceeds a threshold and the hypothetical transfer policy includes copying the unit of data into the read cache. In an embodiment in which the hypothetical transfer policy is the always transfer policy, the performance indicator is a fraction of write-cache data that would have been read from the read cache 206 over a time window if all data flushed from the write cache 204 to the storage 202 over the time window had been copied to the read cache 206 upon flushing to the storage 202.

In an embodiment, if the performance indicator does not exceed the threshold, the method 400 further comprises a step of copying the unit of data to the read cache 206 if a default transfer policy includes copying the unit of data into the read cache 206.

In an alternative embodiment, the method 400 further comprises a step of setting a copy-to-read-cache flag for each particular unit of data read from the write cache 204. In this alternative embodiment, if the performance indicator does not exceed the threshold, the method 400 further comprises a step of copying the unit of data to the read cache 206 upon flushing the unit of data to the storage 202 if the copy-to-read cache flag for the unit of data is set.

In an alternative embodiment, the hypothetical transfer policy, the performance indicator, and the threshold are a first hypothetical transfer policy, a first performance indicator, and a first threshold, respectively. In this alternative embodiment, the method 400 further comprises a step of simulating a second hypothetical transfer policy for copying the units of data from the write cache 204 to the read cache 206 upon flushing the units of data to the storage 202 to provide a second performance indicator for the second hypothetical transfer policy. In this alternative embodiment, if the first performance indicator does not exceed the first threshold but the second performance indicator exceeds a second threshold, upon flushing each unit of data to the storage 202, the method 400 further comprises a step of copying the unit of data from the write cache 204 to the read cache 206 if the second hypothetical transfer policy includes copying the unit of data from the write cache 204 to the read cache 206 upon flushing the units of data to the storage 202.

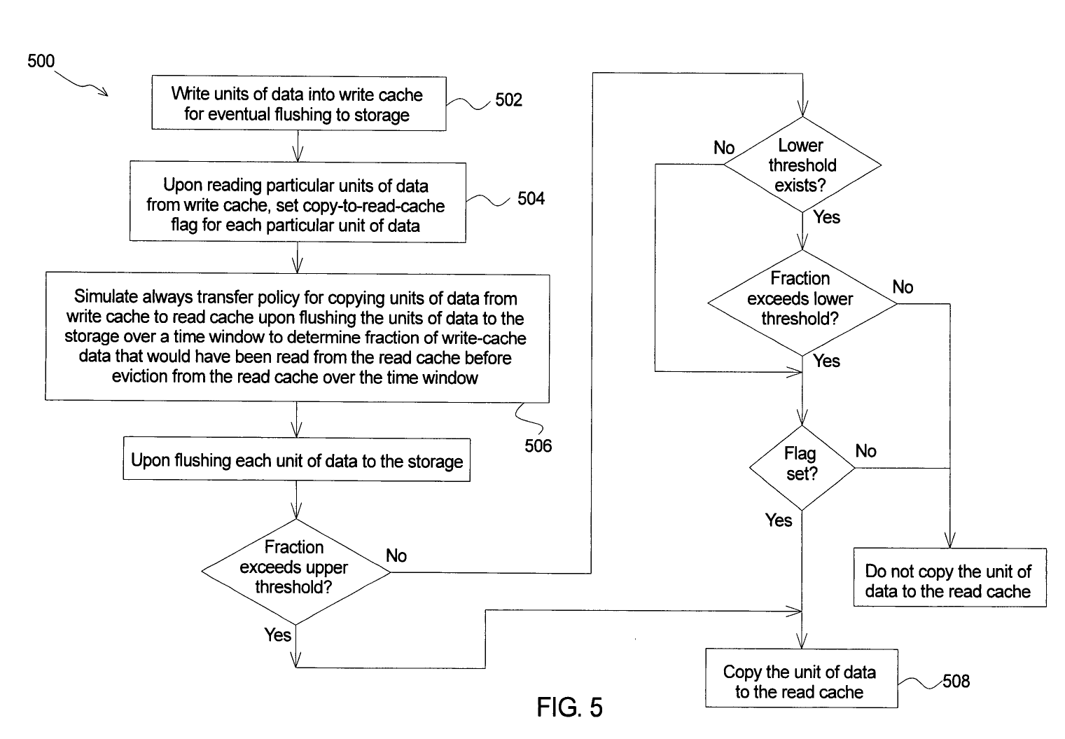

Another embodiment of a method of caching data of the present invention is illustrated as a flow chart in FIG. 5. The method 500 employs a first step 502 of writing units of data to the write cache 204 (FIG. 2) for eventual flushing to the storage 202. Upon reading particular units of data from the write cache 204, the method employs a second step 504 of setting a copy-to-read-cache flag for each particular unit of data.

In a third step 506, the method 500 simulates an always transfer policy over a time window. If employed, the always transfer policy copies all units of data from the write cache 204 to the read cache 206 upon flushing the units of data to the storage 202 over the time window. The simulation of the always transfer policy determines a fraction of write-cache data that would have been read from the read cache 206 before eviction from the read cache 206. The time window may be a recent time window (e.g., 1 min. or 5 mins.) or a longer time window (e.g., a time window for eviction from the read cache). Further, the fraction may be weighted (e.g., using exponential averaging) so that the fraction reflects more recently accessed data rather than assigning equal weight to recently accessed data and previously accessed data.

Upon flushing each unit of data to the storage 202, the method 500 employs a fourth step 508 of copying each unit of data into the read cache 206 under one of three conditions. The first condition is that the fraction of the write-cache data that would have been read from the read cache 206 before eviction for the always transfer policy exceeds an upper threshold. The second condition is that a lower threshold for the fraction exists, the fraction exceeds the lower threshold, and the copy to read cache flag for the unit of data is set. The third condition is that a lower threshold for the fraction does not exist and the copy to read cache flag for the unit of data is set.

The foregoing detailed description of the present invention is provided for the purposes of illustration and is not intended to be exhaustive or to limit the invention to the embodiments disclosed. Accordingly, the scope of the present invention is defined by the appended claims.

What is claimed is:

1. A method of caching data comprising the steps of:
writing units of data into a write cache for eventual flushing to storage;
upon reading particular units of data from the write cache, setting a copy-to-read-cache flag for each particular unit of data; and
upon flushing each unit of data to the storage, copying the unit of data into a read cache if the copy-to-read-cache flag for the unit of data is set.

2. The method of claim 1 further comprising the step of saving a timestamp for each unit of data, the timestamp indicating a time of writing the unit of data into the write cache.

3. The method of claim 2 further comprising the step of employing the timestamp to determine an insertion point for an identifier of the unit of data in a caching policy queue upon copying the unit of data into the read cache.

4. The method of claim 1 wherein a caching policy is selected from a least recently used caching policy, a least frequently used caching policy, a random caching policy, an adaptive replacement caching policy, a first-in-first-out caching policy, and another caching policy.

5. The method of claim 1 wherein the units of data comprise blocks of data.

6. The method of claim 1 wherein the units of data comprise portions of files or files.

7. The method of claim 1 wherein the units of data comprise database records.

8. A method of caching data comprising the steps of:
writing units of data into a write cache for eventual flushing to storage;
simulating a transfer policy for copying the units of data from the write cache to a read cache upon flushing the units of data to the storage to determine a performance indicator for the transfer policy; and
upon flushing each unit of data to the storage, copying the unit of data into the read cache if the performance indicator exceeds a threshold and the transfer policy includes copying the unit of data into the read cache.

9. The method of claim 8 wherein the performance indicator does not exceed the threshold and further comprising the step of copying the unit of data into the read cache upon flushing the unit of data to the storage if a default transfer policy includes copying the unit of data into the read cache.

10. The method of claim 8 wherein the transfer policy is an always-transfer policy.

11. The method of claim 10 wherein the performance indicator comprises a fraction of write-cache data that would have been read from the read cache before eviction from the read cache if all data flushed from the write cache to the storage had been copied to the read cache upon flushing to the storage.

12. The method of claim 11 further comprising the step of setting a copy-to-read-cache flag for each particular unit of data read from the write cache.

13. The method of claim 12 wherein the performance indicator does not exceed the threshold and further comprising the step of copying the unit of data into the read cache upon flushing the unit of data to the storage if the copy-to-read-cache flag for the unit of data is set.

14. The method of claim 12 wherein the threshold is an upper threshold.

15. The method of claim 14 wherein the performance indicator does not exceed the upper threshold and further comprising the step of copying the unit of data into the read cache upon flushing the unit of data to the storage if the performance indicator exceeds a lower threshold and the copy-to-read-cache flag for the unit of data is set.

16. The method of claim 8 wherein the transfer policy, the performance parameter, and the threshold are a first transfer policy, a first performance parameter, and a first threshold, respectively, and further comprising the step of simulating a second transfer policy for copying the units of data from the write cache to the read cache upon flushing the units of data to the storage which provides a second performance indicator for the second transfer policy.

17. The method of claim 16 wherein the first performance indicator does not exceed the first threshold and further comprising the step of copying the unit of data into the read cache upon flushing the unit of data to the storage if the second performance indicator exceeds a second threshold and the second transfer policy includes copying the unit of data into the read cache.

18. The method of claim 17 wherein the second performance indicator does not exceed the second threshold and further comprising the step of copying the unit of data into the read cache upon flushing the unit of data to the storage if a default transfer policy includes copying the unit of data into the read cache.

19. A method of caching data comprising the steps of:
writing units of data into a write cache for eventual flushing to storage;
upon reading particular units of data from the write cache, setting a copy-to-read-cache flag for each particular unit of data;
simulating an always transfer policy for copying all units of data from the write cache to the read cache upon flushing the units of data from the write cache over a time window to determine a performance indicator for write-cache data that would have been read from the read cache before eviction from the read cache if all data flushed from the write cache to the storage over the time window had been copied to the read cache upon flushing to the storage; and
upon flushing each unit of data to the storage:
if the performance indicator for the write-cache that would have been read from the read cache before eviction for the always transfer policy exceeds an upper threshold, copying each unit of data into the read cache; otherwise
if a lower threshold for the performance indicator exists and the performance indicator exceeds the lower threshold, copying each unit of data into the read cache if the copy-to-read-cache flag for the unit of data is set; otherwise
copying each unit of data into the read cache if the copy-to-read-cache flag for the unit of data is set.

20. The method of claim 19 wherein the performance indicator is a fraction of the write-cache data that would have been read from the read cache before eviction from the read cache if all data flushed from the write cache to the storage over the time window had been copied to the read cache upon flushing to the storage.

21. The method of claim 19 wherein the performance indicator is a weighted fraction of the write-cache data that would have been read from the read cache before eviction from the read cache if all data flushed from the write cache to the storage over the time window had been copied to the read cache upon flushing to the storage.

22. The method of claim 21 wherein the weighted fraction is determined using exponential averaging.

23. A computer readable media comprising computer code for implementing a method of caching data, the method of caching the data comprising the steps of:
writing units of data into a write cache for eventual flushing to storage;
upon reading particular units of data from the write cache, setting a copy-to-read-cache flag for each particular unit of data; and
upon flushing each unit of data to the storage, copying the unit of data into a read cache if the copy-to-read-cache flag for the unit of data is set.

24. A computer readable media comprising computer code for implementing a method of caching data, the method of caching the data comprising the steps of:
writing units of data into a write cache for eventual flushing to storage;
simulating a transfer policy for copying the units of data from the write cache to a read cache upon flushing the units of data to the storage to determine a performance indicator for the transfer policy; and
upon flushing each unit of data to the storage, copying the unit of data into the read cache if the performance indicator exceeds a threshold and the transfer policy includes copying the unit of data into the read cache.

25. A computer readable media comprising computer code for implementing a method of caching data, the method of caching the data comprising the steps of:
writing units of data into a write cache for eventual flushing to storage;
upon reading particular units of data from the write cache, setting a copy-to-read-cache flag for each particular unit of data;
simulating an always transfer policy for copying all units of data from the write cache to the read cache upon flushing the units of data from the write cache over a time window to determine a performance indicator for write-cache data that would have been read from the read cache before eviction from the read cache if all data flushed from the write cache to the storage over the time window had been copied to the read cache upon flushing to the storage; and
upon flushing each unit of data to the storage:
if the performance indicator for the write-cache that would have been read from the read cache before eviction for the always transfer policy exceeds an upper threshold, copying each unit of data into the read cache; otherwise
if a lower threshold for the performance indicator exists and the performance indicator exceeds the lower threshold, copying each unit of data into the read cache if the copy-to-read-cache flag for the unit of data is set; otherwise
copying each unit of data into the read cache if the copy-to-read-cache flag for the unit of data is set.
